(19) United States
(12) Patent Application Publication
(10) Pub. No.: US 2013/0099638 A1
(43) Pub. Date: Apr. 25, 2013

(54) PRINTER CABINET LATCH ASSEMBLY

(71) Applicant: Malgorzata Pala, Burr Ridge, IL (US)

(72) Inventor: Malgorzata Pala, Burr Ridge, IL (US)

(21) Appl. No.: 13/278,346

(22) Filed: Oct. 21, 2011

(51) Int. Cl. B41J 29/02

(52) U.S. Cl. 312/223.2

(57) ABSTRACT

A printer cabinet for support of a printer. The cabinet has a number of latch hooks protruding from recesses in its top surface. The printer has a number of recesses in its bottom plate that receive the latch hooks. The latch hooks are positioned in an unengaged position or a locked engaged position depending upon the position of the cabinet latch assembly handles.

### Cross-Reference to Related Application

None.

### BACKGROUND OF THE INVENTION

I. Field of the Invention

The present disclosure relates generally to printer stands, and more specifically to a printer stand and cabinet having a latch assembly to engage the printer thereto and thereby provide a stable support surface therefore.

II. Description of the Prior Art

Printer stands have become increasingly popular for their ease of installation and relatively low cost in association for the benefits they provide. Designed to support a variety of office networks printers and/or other multifunctional devices, such printer stands raise the subject device to a more convenient and easily accessible height. Stands that also include cabinets provide the added benefit of a storage compartment for extra paper and other supplies. These stands/cabinets may further be mobile and include lockable wheels for overall positioning of the device. Many of these stands/cabinets are custom designed for a particular printer or other device and accordingly may complement the form factor of the device or otherwise provide an aesthetic appeal.

Prior known office printer stands/cabinets have been lax in an essential element of the support of the device, that is, the secure attachment of the device to the stand/cabinet. Typically, printers and/or other multifunctional devices are placed on top of the stand/cabinet and remain in place solely via the force of gravity. FIG. 1 shows a network printer 10 positioned atop such a conventional printer stand 12. Alternatively, and as shown in FIG. 2, some conventional cabinets 20 may include a number of guide pins 22 protruding from the top support surface 24 of the cabinet 20. These guide pins 22 are designed to operatively engage corresponding recesses located in the bottom surface of the device.

Whether the printer or other such device is supported solely via gravity or in combination with pegs and recesses, there remains the issue of it slipping off center and/or even worse, falling off of the stand/cabinet altogether. For example, the stand in FIG. 1 has four supports 14, and while they help to maintain the stand in position, if the printer happens to be accidently bumped by a user it is likely that it will slip from the illustrated square position on the stand. Similarly, the cabinet in FIG. 2 has four lockable wheels 26 and numerous supports 28 to maintain its position. Again, if accidently bumped, or perhaps during original placement or repositioning, there remains the possibility of slippage, disengagement or even the toppling of the device off of the stand/cabinet. This is obviously a dangerous disadvantage of the current stand/cabinet designs.

Accordingly, it is a general object of this disclosure to provide a safe coupling of the printer or other such device with its associated stand/cabinet.

It is a more specific object of the present disclosure to provide a latch assembly for the secure engagement of the bottom surface of the device to the top surface of the cabinet.

These and other objects, features and advantages of this disclosure will be clearly understood through a consideration of the following detailed description.

### SUMMARY OF THE INVENTION

According to an embodiment of the present disclosure, there is provided a printer cabinet for support of a printer. The cabinet includes a base member with a top printer support surface. A latch assembly is movably coupled to the base and includes one or more hooks for engaging one or more recesses on the bottom surface of the printer.

There is also provided a cabinet including a base member with a top printer support surface, a bottom surface and a storage compartment there between. A latch assembly is pivotally coupled to the base member and includes a hook, a pivot point and a handle. The handle enables a user to pivot the hook from an unlocked position disposed within a recess in the bottom surface of the printer to a locked position engaging the recess.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 a perspective view of a conventional stand and its associated printer.

FIG. 2 is a perspective view of a conventional cabinet.

FIG. 3 is a perspective view of a cabinet according to the principles of an embodiment of the present disclosure.

FIG. 4 is a top plan view of the cabinet of FIG. 3.

FIG. 5 is a front view of the cabinet of FIG. 3.

FIG. 6 is a side view of the cabinet of FIG. 3.

FIG. 7 is a bottom view of the cabinet of FIG. 3.

FIG. 8a is a perspective view of the latch assembly of the cabinet of FIG. 3.

FIG. 8b is a perspective view of the latch holder of the cabinet of FIG. 3.

FIG. 9 is a perspective view of the bottom surface of the printer associated with the cabinet of FIG. 3.

FIG. 10a is a rear right side corner perspective view of the cabinet of FIG. 3 having the latch assembly in the open position.

FIG. 10b is a rear right side corner perspective view of the cabinet of FIG. 3 having the latch assembly in the closed and engaged position.

FIG. 11a is a top plan view of a cabinet according to the principles of another embodiment of the present disclosure having the latch assembly in the open position.

FIG. 11b is an enlarged view of the handle of the latch assembly of FIG. 11a.

FIG. 12a is a top plan view of the cabinet of FIG. 11a having the latch assembly in the closed and engaged position.

FIG. 12b is an enlarged view of the handle of the latch assembly of FIG. 12a.

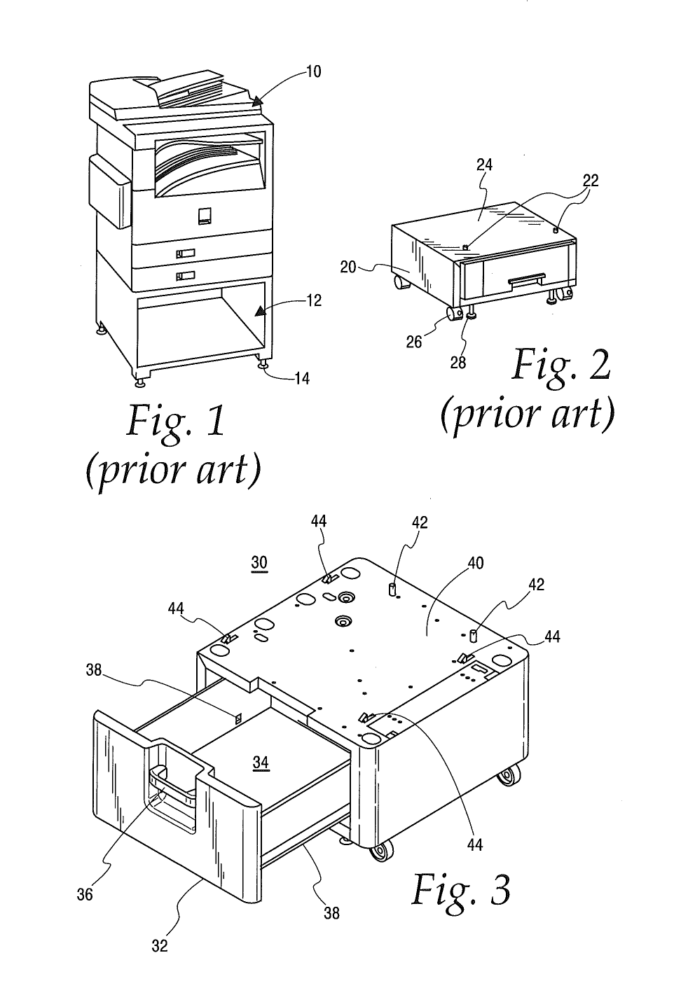

### DESCRIPTION OF THE PREFERRED EMBODIMENTS

One or more embodiments of the subject disclosure will now be described with the aid of numerous drawings. Unless otherwise indicated, use of the term “printer” will be understood to include stand alone printers, network printers, copiers, facsimile machines, as well as other multifunctional devices and the like. Additionally, the use of the term “cabinet” will be understood to mean stands, supports, cabinets and the like.

In any event, turning now to the Figures, and in particular FIG. 3, a base member or printer cabinet 30 is illustrated with a perspective front view having an open drawer front assembly 32. This drawer assembly includes a storage compartment 34 for holding supplies that is accessed by pulling on the front handle 36 and moving the assembly 32 via slides 38. While the top surface 40 of the cabinet 30 does include a set of guide pins 42, it is the latch hook 44 that will securely couple the printer.

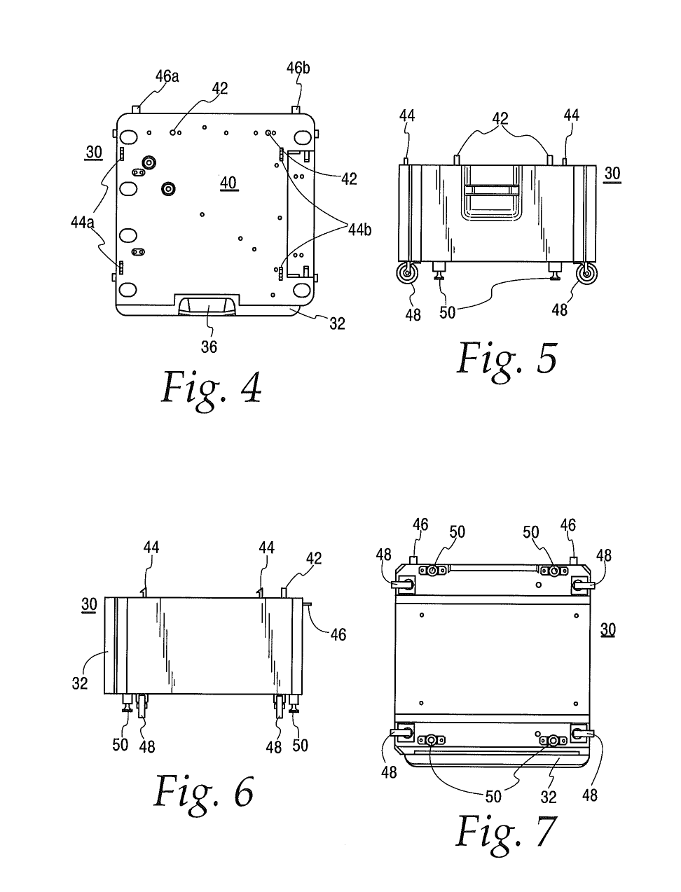

The top surface 40 of the cabinet 30 is illustrated by the top view of FIG. 4. Together with the two guide pins 42, FIG. 4 shows four latch hooks 44. Latch hooks 44a are positioned in either an opened/unengaged or a closed/engaged position via latch handle 46a. Similarly, latch hooks 44b are positioned in either an open/unengaged or a closed/engaged position via latch handle 46b.

The guide pins 42 and the latch hooks 44 and their respective locations on the cabinet 30, are also shown in the front view of FIG. 5 and the side view of FIG. 6. Additionally, the respective locations of the latch handles 46 on the cabinet 30 are shown in the side view of FIG. 6 and the bottom view of FIG. 7. FIGS. 5-7 are further illustrative of the respective locations of the swivel coasters or lockable wheels 48 and the base leveler or support feet 50 of the cabinet 30.

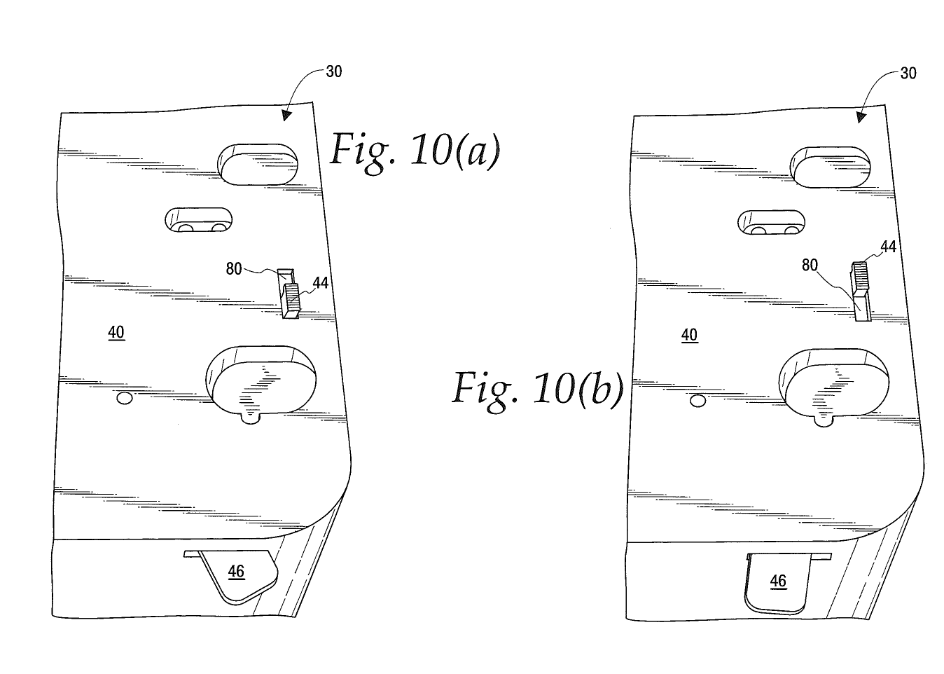

Turning now to FIGS. 8a and 8b and the mechanism of the latch hooks and their respective positioning are illustrated. Latch assembly 60 is positioned inside the cabinet 30 and is secured in movable engagement to the bottom of the top surface 40 via latch holder 70 through screws and holes 72 in both the holder 70 and the bottom (not shown) of the top surface 40 of the cabinet 30. Although the latch assembly is under the top surface 40 of the cabinet 30, the latch hooks 44 protrude through cabinet recesses 80 (see FIGS. 10a and 10b). The latch assembly includes a cam 62, a latch handle 46 and a pivot hole 64. The latch assembly 60 is further secured to the bottom of the top surface 40 of the cabinet 30 via a screw and tooth washes through the pivot hole 64. This allows the latch assembly 60 to move forward and back 66 when the handle is pivoted 68 about the pivot point hole 64. This forward and back movement positions the latch hooks 44 in either an engaged or an unengaged position (supra) depending on the position of the latch handles 46.

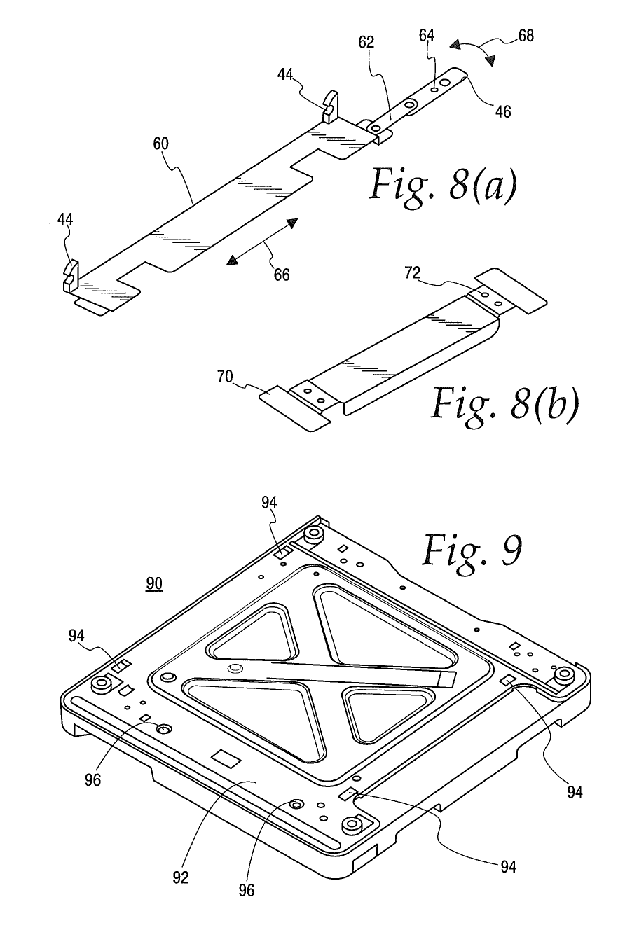

The latch hooks 44 have been designed to engage and lock down on the bottom surface 90 of the printer, see FIG. 9. In particular, the bottom surface 90 of the printer includes a plate 92 with plate recesses 94. When the printer is placed on top of the cabinet 30, guide pins 42 enter and nest within plate holes 96. Similarly, latch hooks 44 enter and nest within plate recesses 94.

Turning now to FIGS. 10a and 10b, when the handles 46 are in the open position, as shown in FIG. 10a, the latch hooks 44 are disposed or nested within plate recesses 94. However, when the handles are in the closed position, as shown in FIG. 10b, the latch hooks 44 are engaged and locked in place against the plate recesses 94 of the printer. While in this locked position, the printer is securely fastened to the cabinet 30. Accordingly, the printer cannot slip off center and/or fall off of the cabinet and the dangerous disadvantage of prior art cabinets is eliminated.

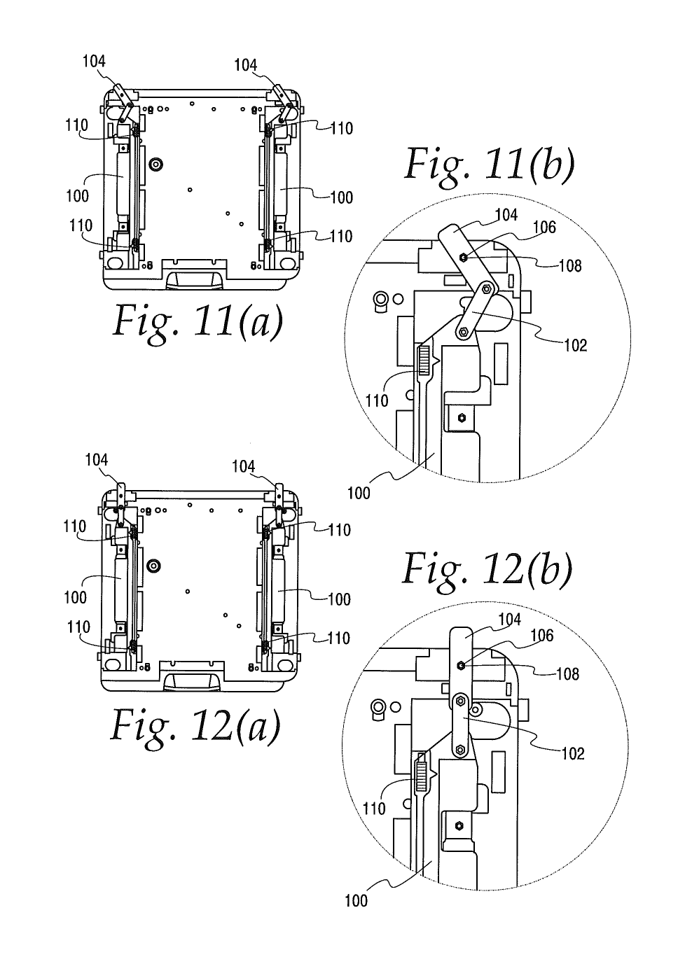

An alternate embodiment of the latch assembly 100 is shown in FIGS. 11 and 12. The latch assembly 100 includes a cam 102, a latch handle 104 and a pivot hole 106. Screw 108 and tooth washers further secure the latch assembly 100 to the top surface of the cabinet through the pivot hole 106. As previously discussed, when the handles 104 are in the open position, as shown in FIGS. 11a and 11b, the latch hooks 110 are merely disposed or nested within associated plate recesses. However, when the handles 104 are in the closed position, as shown in FIGS. 12a and 12b, the latch hooks 110 are engaged and locked in place against the plate recesses of the printer.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A printer cabinet for support of a printer comprising:
a base member having a top surface for support of a printer;
a latch assembly movably coupled to said base member, said assembly having one or more hooks extending from said top surface of said base member; and
said assembly having a handle for moving said hooks from a first position, wherein said hooks are disposed within associated recesses on a bottom surface of said printer, to a second position wherein said hooks are engaged with said recesses.

2. The printer cabinet of claim 1 wherein said top surface of said base member further includes one or more guide pins extending therefrom for positioning within associated holes on said bottom surface of said printer.

3. The printer cabinet of claim 1 wherein said base member includes multiple latch assemblies.

4. The printer cabinet of claim 1 wherein said base member includes supports extending from a bottom surface of said base member.

5. The printer cabinet of claim 4 wherein said supports include lockable wheels.

6. A cabinet comprising:
a base member having a top surface for support of a printer, a bottom surface, and at least one storage compartment therebetween;
a latch assembly having a hook, a pivot point and a handle, said assembly moveably coupled to said base member about said pivot point; and
said handle enabling a user to pivot said hook from an unlocked position disposed within an associated recess on a bottom surface of a printer to a locked position engaging said associated recess.

7. The cabinet of claim 6 wherein said top surface of said base member further includes one or more guide pins extending therefrom for positioning within associated holes on said bottom surface of said printer.

8. The cabinet of claim 6 wherein said base member includes multiple latch assemblies.

9. The cabinet of claim 6 wherein said base member includes supports extending from a bottom surface of said base member.

10. The cabinet of claim 6 wherein said supports include lockable wheels.
